(19) United States
(12) Patent Application Publication
(10) Pub. No.: US 2007/0248762 A1
(43) Pub. Date: Oct. 25, 2007

(54) Process for coating synthetic resin compositions

(76) Inventors: Toshikazu Kobayashi, Chadds Ford, PA (US); Ayumu Yokoyama, Clarkston, MI (US); Shawn Xiang Zhang, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/786,387

(22) Filed: Apr. 10, 2007

Related U.S. Application Data
(60) Provisional application No. 60/791,395, filed on Apr. 12, 2006.

(51) Int. Cl. B05D 7/00

(52) U.S. Cl. 427/407.1

(57) ABSTRACT

Synthetic resins, such as thermoplastics and thermosetting resins, which have certain specified surface resistivities and static dissipation voltage values, are advantageously used as substrates to be coated in electrostatically assisted coating processes. Thus less of an electrically conducting additive, which is often deleterious to the substrate physical properties, may be used and/or additives which do not increase the electrical conductivity of the substrate to much may be used.

### CROSS REFERENCE TO RELATED APPLICATIONS

This application claims the benefit of U.S. Provisional Application No. 60/791,395 filed Apr. 12, 2006.

### FIELD OF THE INVENTION

Synthetic resin compositions which have relatively high electrical resistance and relatively high static dissipation, surprisingly have excellent coating buildups when used in electrostatically assisted coating processes.

### TECHINCAL BACKGROUND

Synthetic resins (polymers) including thermosets such as epoxy resins, melamine resins, and so-called sheet molding resins (or compounds), as well as thermoplastics such as polyolefins, polyamides, polyesters and many others are ubiquitous in modern life. They have a myriad of uses, and in some of these uses it is desirable, often for aesthetic reasons, for the resin to have a pleasing surface appearance and/or a certain color. While the latter may be accomplished by coloring the resin composition itself, in many instances it may be more desirable to coat (paint) the resin with a coating. Coated items often have a better appearance than just the uncoated resin item. In addition if the resin item is part of a larger assembly that includes metal, the metal will often be coated (painted) for aesthetic and/or anticorrosion purposes and if the metal and resin parts are both coated with the same coating, they will have an often desirable uniform appearance.

One type of coating process which is used extensively, especially industrially, is so-called electrostatically assisted coating. In this process an electrically grounded substrate (the item to be coated) is sprayed by or dipped into coating particles or droplets which are charged with a high voltage difference from ground. The particles are thus electrostatically attracted to the substrate surface which of course is coated by the particles. There are numerous advantages to electrostatically assisted coating, for instance, faster buildup of the desired coating thickness, higher coating efficiency, i.e., a higher percentage of the coating particles or droplets ends up on the desired surface, more uniform coating especially on curved surfaces, and less over-spray which is waste and may be environmentally deleterious. Thus for instance electrostatically assisted coating is used to coat vehicle bodies (including automobiles, trucks, railroad cars, locomotives, snowmobiles, etc.) and appliance cabinets. See for instance S. J. Babinec, et al., in R. A. Ryntz et al., Ed., Coating of Polymers and Plastics, Marcel Dekker, Inc., New York, 2003, p. 34-44, which is hereby included by reference.

However one requirement for using this type of coating process is that the substrate to be coated be electrically conductive to a certain extent. Normally synthetic resins, including thermoplastics and thermosets, are not electrically conductive enough, and so can't simply be used in this process. One solution to this problem is to coat the synthetic resin with an electrically conductive primer, but this adds another step and additional cost. Another method is to make the synthetic substrate resin composition electrically conductive (enough) by adding to it an electrically conducting filler such as (and probably most commonly) graphite (carbon) in many different forms such as carbon black, graphite flakes and carbon nanotubes. However many such electrically conducting fillers, some while not adding much to the cost, deleteriously affect many other properties of the composition, for example toughness and/or final appearance of the coated part. Therefore minimizing the use of such fillers is important.

“The published literature consensus of a target conductivity for electrostatic painting appears to be a value of about 10⁻⁵ to about 10⁻⁶ S/cm.” (S. J. Babinec et al., supra, p. 41). While this is much less electrically conductive than a typical metal it often still requires substantial amounts of an electrically conductive filler to achieve this type of electrical conductivity in a synthetic resin. Thus it would be desirable to find ways of reducing the amount of conductive filler needed, and/or to find other conductive fillers which would be useful but not as deleterious to other properties of the resin composition.

### SUMMARY OF THE INVENTION

This invention concerns, a process, comprising, coating a surface of a synthetic resin composition with a coating material, wherein said coating process is electrostatically assisted, wherein the improvement comprises, said composition has a surface resistance of about 5×10⁷ ohms/sq or more, and has a dissipation voltage value of less than about 5 kV.

### BRIEF DESCRIPTION OF THE DRAWING

FIG. 1 is a top (or bottom) view of the test setup for measuring the dissipation voltage value.

### DETAILS OF THE INVENTION

Herein certain terms are used and they are defined below:

By a “synthetic resin” is meant a polymeric material [in the case of thermosets before and/or after crosslinking (setting)] made by man. Useful materials include thermoplastic and thermosetting resins. The composition may contain natural resins, but must contain at least one synthetic resin. Preferably at least 40%, more preferably 50% by weight, of the total composition are synthetic resins (if more than one synthetic resin is present it is the total of those resins that is used in the calculation).

“Surface resistance” in ohms/sq(uare) is measured by ASTM Method D257, using an applied voltage of 5000 volts. Preferably the surface resistance is about 1.0×10⁸ ohms/sq or more, more preferably 5.0×10⁸ or more, and very preferably about 1.0×10⁹ ohms/sq or more.

The “dissipation voltage value” in kV (kilovolts) is measured as described below in Test Method A. The dissipation voltage value is about 5 kV or less, preferably about 3 kV or less.

The synthetic resin compositions to be painted may be prepared and shaped by methods usually used for the particular type of resin used. For instance thermoplastics may be melt mixed with the various ingredients that make up the composition in typical melt mixing types of apparatus, such as single and twin screw extruders, and kneaders. Since some ingredient that will decrease the surface resistivity is needed (see below for types of useful materials), this too will be added in a conventional manner. Carbon black for instance may be fed into the back of a twin screw extruder or it may be added in a side feeder. It is usually important to obtain a good dispersion of the ingredients, especially whatever is decreasing the surface resistance, in order to efficiently use that ingredient, i.e., to use as little of that ingredient as possible consistent with obtaining the desired surface resistivity.

For thermosets the various ingredients may be mixed into the resin before the resin is crosslinked. This may be typically done by melting the resin (assuming it is not already a liquid at ambient temperature), and adding the various ingredients and dispersing them in the usually relatively (compared to thermoplastics) low viscosity liquid. An efficient mixer or dispersion mill may be used for this purpose.

Almost any synthetic resin may be used, so long as the coating can adhere to the resins surface. Useful thermoplastics include a polyolefin (especially polyethylene and its copolymers, polypropylene and its copolymers, and polystyrene), a poly(meth)acrylate [especially poly(methyl methacrylate)], a polycarbonate, a fluorinated polymer, a polyester [especially poly(ethylene terephthalate), poly(1,3-propylene) terephthalate), poly(1,4-butylene terephthalate), poly(1,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a thermotropic liquid crystalline polymer, a polysulfone, poly(oxymethylene) homo- and copolymers, a polysulfide, a polyketone (including polyketones containing ether linking groups), an acrylonitrilebutadiene-styrene (ABS) copolymer, a chlorinated polymer [especially poly(vinyl chloride) and poly(vinylidene chloride)], or a thermoplastic elastomer, especially a thermoplastic block co(polyester-polyether), a block copolyolefin, a thermoplastic urethane or a thermoplastic elastomeric polymer blend. Also blends of two or more polymers may be used.

Likewise, many different types of thermosetting reins may be used. These include an epoxy resin, a melamine resin, a phenolic resin, so-called sheet molding compounds of various types, an amino resin, an unsaturated polyester resin, a polyurethane resin, a silicone resin, an alkyd resin, an allyl resin, and a furane resin. Mixtures of compatible thermosetting resins may also be used.

Any of these synthetic resins may contain other conventional ingredients [besides the additive(s) that increase electrical conductivity], such as filler(s), reinforcing agent(s), pigment(s), antioxidant(s), lubricant(s), mold release, flame retardant, crystallization inhibitor(s), crystallization promoter(s) and/or accelerator(s), plasticizer(s) and toughening agent(s). These may be present in conventional amounts.

After formation of the resin composition a thermoplastic may be formed into a part by typical melt forming methods, for instance injection molding, blow molding, rotomolding, or extrusion. Other common methods forming methods such as thermoforming may also be used. For thermosets, typically they are mixed with curing agents and added to an often heated mold where they set up (crosslink) to a solid polymeric material.

As mentioned above, because the electrical conductivity of the resin composition does not have to be as high as previously thought lower amounts of electrically conductive additives can be used. However, some other additives that when added do not increase the electrical conductivity to previously “required” levels can now also be used. Such additives include ion conducting polymers. Some of these can be used in the absence of more conventional electrically conductive additives such as carbon black, or in addition to these types of additives.

By an ion conducting polymer is meant a polymer which is capable of conducting ions. One type of ion conducting polymer, which is commercially available is a poly(ether-ester-amide) (PEEA) available under the tradename Pelestat® 6321 and 6500 (Sanyo Chemical Industries, Ltd., Kyoto, Japan), Irgastat® P22 (Ciba Specialty Chemicals, Tarrytown, N.Y. 10591, U.S.A.), and Pebax® MV1074 and MH1657 (Arkema, Inc., Philadelphia, Pa. 19103, U.S.A.). The conductivity of such polymers requires that there be an ionic material present, such as an alkali metal salt which preferably is at least somewhat soluble in the polymer. Generally speaking, up to a point, the more ionic material present in the ion conducting polymer the higher its electrical conductivity will be. Such ion conducting polymers are presently used, for example, as additives in other thermoplastics to make these thermoplastics “anti-static”. However they have not been used in electrostatically assisted painting processes to make a synthetic resin electrically conductive enough to be useful in such a process, particularly a composition with the surface (electrical) resistance and dissipation voltage values described herein.

The ion conducting polymer may be mixed into the synthetic resin, preferably a thermoplastic synthetic resin, by conventional means for forming resin compositions, for example melt mixing for thermoplastic compositions. The amount of ion conducting polymer used will vary with several factors, such as the final surface resistance desired, the inherent electrical conductivity of the ion conducting polymer, and what other ingredients are present in the overall composition. However typically about 5 to about 35 percent by weight of the ion conducting resin of the total of the synthetic resins present in the composition, including the ion conducting polymer if it is synthetic, are used.

The present process is useful for coating various items that are normally coated using electrostatically assisted spraying, such as vehicle bodies and appliances.

Test Method A Mold a sheet of the synthetic resin composition to a rectangular size of 7.5 cm×12.5 cm×3 mm thick or take a larger sheet and cut a rectangle to this size. Electrically contact the plastic with steel panel (10 cm×30 cm) by inserting aluminum foil between the center of the plastic panel and the center of the steel panel. The plastic plate is then attached to the steel panel by using double-sided adhesive tape (1.5 cm wide) at both of the longer edges of the plastic panel, and also a magnet. This assembly is then hung vertically to a frame that is grounded, so that the steel plate is also grounded.

The synthetic resin sheet is then sprayed with “charged air” at −90 kV, 0.9 bar (gauge) pressure from a distance of 1 cm for a period of 30 sec, at a temperature of about 15-22° C. and a relative humidity of 40-60%. The preferred spray gun is a Nordson Sure Coat® Spray Gun (Nordson Corp., Amherst, Ohio 44001, USA), although any electrostatic hand-held spray gun (which can produce the proper conditions) can be used. During spraying the spray gun is moved around over the surface of the plastic plate.

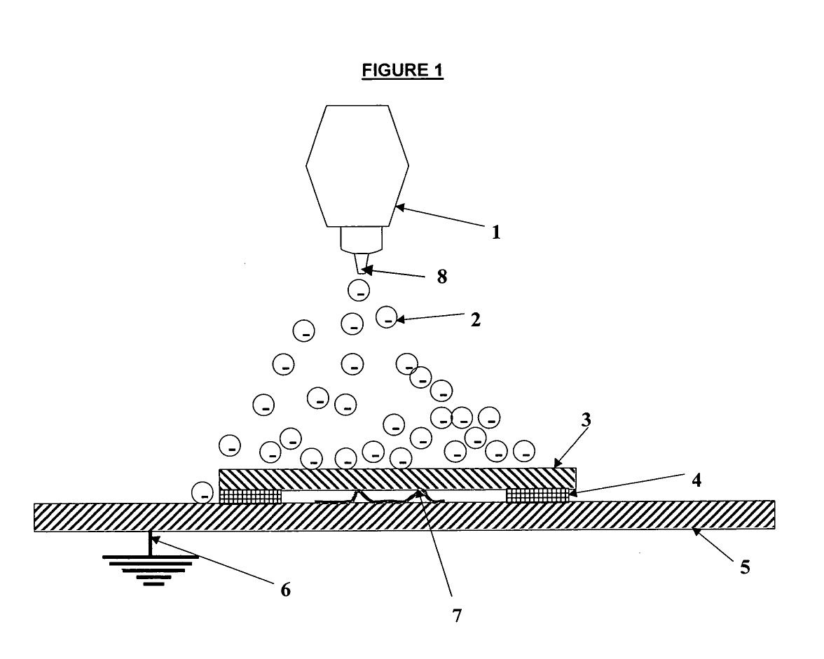

This spraying operation is shown in FIG. 1, which is a top (or bottom) view of the operation. 1 is the complete spray gun with the nozzle 8 pointing towards the synthetic molded resin sheet 3. The charged air particles are represented by the circles with negative charges in them 2, and they travel from 8 towards 3. 3 is held to a steel backer plate 5 by two sided tape (usually masking tape) 4. In between 3 and 5 is aluminum foil 7 which contacts both 3 and 5, thereby electrically connecting 3 and 5. 5 is held on a frame (not shown), usually by magnets (not shown), so that the surface of 3 which is being “coated” by 2 is vertical. In addition 5 is connected by 6 to a ground, in other words 5 is electrically grounded, usually to the frame which in turn is also grounded (not shown).

Ten seconds after the spraying has stopped the residual voltage on the synthetic resin plate is measured by using an electrostatic field meter whose detector is 2.5 cm away from the surface of the resin plate (the meter will need to be in place right after the spraying and for the ten second time reading). In other words the meter takes the place of 1 in FIG. 1, with the detector 2.5 cm from the surface of 3, and centered on the plastic plate. A preferred meter is a SIMCO® Electrostatic Field Meter FMX-002 (Simco Industrial Static Control, Hatfield, Pa. 19440, USA).

This absolute value of the electrostatic field meter reading (in kV) after 10 seconds is the dissipation voltage value. In other words, it doesn't matter if the meter reading is positive or negative, the dissipation voltage is always a positive number. Tests indicate that the reproducibility of this method is about ±0.4 kV.

Surface Resistivity Surface resistivity is measured at approximately room temperature and 50% relative humidity using ASTM Method D257 using an applied voltage of 5000 volts.

Painting Procedure The plastic plaque was first weighed, and then attached vertically to a steel frame using the procedure described above for the dissipation voltage value (including the steel backer plate and aluminum foil). The panel was sprayed with a Primer Surfacer (#176-2477, E. I DuPont de Nemours & Co., Inc., Wilmington, Del. 19898, U.S.A.) using an electrostatic bell (77 mm Serrated Toyota Cartridge Bell, ABB Inc, Norwalk, Conn. 06851, USA, 30,000 rpm) at −90 kV with a paint flow rate of 150 mL/min. The distance between the bell and the panel was 300 mm. Two coats were applied for 80 sec with a 15 sec flash time in between coats. Dry film build was 28-35 μm. The sample was flashed for 7 min, baked in an electric oven at 140° C. for 20 min, cooled and reweighed.

The plaque was rehung vertically (by the same method) and electrostatically sprayed with a black waterborne basecoat (202 Black, E. I. DuPont de Nemours & Co., Inc., Wilmington, Del. 19898, U.S.A.) using an electrostatic bell (65 mm Behr Bell, Durr Industries, Inc., Plymouth, Mich. 48170, USA, 42,500 rpm) at −60 kV with a paint flow rate of 160 mL/min. The distance between the bell and the panel was 300 mm. Two coats were applied for 130 sec with a 70 sec flash time in between coats. Dry film build was 10-15 μm. The sample was flashed for 90 sec, and baked in an electric oven at 104° C. for 4 min. The plaque was reweighed.

The plaque was rehung vertically (by the same method) and electrostatically sprayed with a clearcoat (Kino Clearcoat RC-8139, E. I. DuPont de Nemours & Co., Inc., Wilmington, Del. 19898, U.S.A.) using an electrostatic bell (55 mm serrated Behr Bell, Durr Industries, Inc., 42,500 rpm) at −85 kV with a paint flow rate of 205 mL/min. The distance between the bell and the panel was 300 mm. One coat was applied for 60 sec. Dry film build was 30-35 μm. The sample was flashed for 7 min, and baked in an electric oven at 140° C. for 20 min. The plaque was reweighed.

The weight of each coating (type) was calculated and is reported in the Tables. Generally speaking the higher the weight of each coating the more efficient is the electrostatic spraying, with less overspray. A higher weight is desired.

In the Examples all parts are parts by weight.

In the Examples, the following materials are used:

Araldite® ECN 1299—an Epoxy Cresol Novolac resin from Vantico Inc., Brewster, N.Y. 10509, USA.

Engage® 8180—an ethylene/1-octene copolymer available from the Dow Chemical Co., Midland, Mich. 48674, USA.

EPON® 1002F—an Epoxy resin from Resolution Performance Products, Houston, Tex. 77210, USA.

FTL300—TiO₂ whiskers available from Ishihara Sangyo Kaisha, Ltd., Osaka, Japan.

Irganox® 1010—antioxidant available from Ciba Specialty Chemicals, Tarrytown, N.Y. 10591, USA.

KetjenBlack EC-600JD—a carbon black available from Akzo Nobel Polymer Chemicals LLC, Chicago, Ill. 60607, USA.

Lotader® AX 8900—an ester copolymer available from Atofina Chemicals, Inc., Philadelphia, Pa. 19103, USA.

Loxiol® HOB 7119—a mixture of fatty acid esters (mold release) available from Cognis Corp., Cincinnati, Ohio 45232 USA.

Pelestat® 6321 and 6500—ion conducting polymers available from Sanyo Chemical Industries, Ltd., Kyoto, Japan.

Plasthall® 809—polyethylene glycol 400 di-2-ethylhexanoate.

Polymer A—A poly(ethylene terephthalate) polymer containing 2.5 wt % sepiolite dispersed therein. For dispersion method, see copending U.S. patent application CL2180, application Ser. No. 10/680,286.

Polymer B—ethylene/n-butyl acrylate/glycidyl methacrylate (66/22/12 wt. %) copolymer, melt index 8 g/10 min.

Polymer C—A copolyamide made from 50 mole percent 1,6-daminohexane, 50 mole percent 2-methyl-1,5-diamnopentane, and terephthalic acid.

Polymer D—A polymer blend of 45 mole percent nylon-6,6 and 55 mole percent of a polyamide from 1,6-daminohexane and terephthalic acid.

Polymer E—An EPDM elastomer grated with maleic anhydride.

Polymer F—A poly(1,4-butylene terephthalate) polymer from E. I. DuPont de Nemours & Co. Inc., Wilmington, Del. 19898, USA.

Polymer G—A poly(1,6-cychexylenendimethanol terephthalate) polymer from Eastman Chemical Company, Kingsport, Tenn. 37662, USA.

PPG 3563—a fiber glass from PPG Industry, Inc., Pittsburgh, Pa. 15272, USA.

Talc 9102—a talc mineral from Barretts Minerals Inc., Mt. Vernon, Ind. 47620, USA.

Ultranox® 626—an antioxidant, bis(2,4-di-t-butylphenyl)penterythritol diphosphite, available from GE Specialty Chemicals, Inc., Morgantown, W.Va. 26501 USA.

Vansil® HR 325—wollastonite from R. T. Vanderbilt Co., Norwalk, Conn. 06850, USA.

### EXAMPLES 1-7 AND COMPARATIVE EXAMPLES A-C

Compositions as given in Table 1 were made up in a 30 mm Werner & Pfleiderer twin screw extruder. Polymers A and B, and the Loxiol®, Irganox®, and Ultranox® were fed in the rear of the extruder, while the Plasthall®, and Vansil® were side fed. This composition was then pellet blended with the Pelestat® and fed to a Nissei Japan 6 oz. injection molding machine with the cylinder set at 280° C. and the mold at 120° C., and molding into 7.6 cm×12.7 cm×0.32 cm thick plaques. The plaques were tested for surface resistivity and dissipation voltage values, which are given in Table 1. The plaques were then electrostatically spray painted. Weights of the coatings are given in Table 1.

TABLE 1

| | Example | | | | | | | | | |
|---|---|---|---|---|---|---|---|---|---|---|
| | 1 | 2 | 3 | A | 4 | 5 | B | 6 | 7 | C |
| Polymer A | 69.48 | 65.61 | 61.76 | 69.48 | 65.61 | 61.76 | 69.48 | 65.61 | 61.76 | Steel |
| Polymer B | 8.1 | 7.65 | 7.2 | 8.1 | 7.65 | 7.2 | 8.1 | 7.65 | 7.2 | |
| Loxiol ® HOB7119 | 0.45 | 0.43 | 0.4 | 0.45 | 0.43 | 0.4 | 0.45 | 0.43 | 0.4 | |
| Irganox ® 1010 | 0.09 | 0.09 | 0.08 | 0.09 | 0.09 | 0.08 | 0.09 | 0.09 | 0.08 | |
| Ultranox ® 626 | 0.18 | 0.17 | 0.16 | 0.18 | 0.17 | 0.16 | 0.18 | 0.17 | 0.16 | |
| Plasthall ® 809 | 2.7 | 2.55 | 2.4 | 2.7 | 2.55 | 2.4 | 2.7 | 2.55 | 2.4 | |
| Vansil ® HR325 | 9 | 8.5 | 8 | 5.4 | 5.1 | 4.8 | 5.4 | 5.1 | 4.8 | |
| FTL 300 | | | | 3.6 | 3.4 | 3.2 | 3.6 | 3.4 | 3.2 | |
| Pelestat ® 6321 | | | | | | | 10 | 15 | 20 | |
| Pelestat ® 6500 | 10 | 15 | 20 | 10 | 15 | 20 | | | | |
| Dissipation voltage | 3.20 | 2.50 | 0.09 | 8.00 | 2.00 | 0.00 | 12.00 | 0.60 | 0.50 | 0.00 |
| value, kV | | | | | | | | | | |
| Surface Resistivity, | 7.5E+11 | 7.5E+11 | 3.8E+09 | 7.5E+11 | 7.5E+11 | 6.6E+08 | 7.5E+11 | 7.5E+11 | 7.5E+09 | |
| ohms/sq | | | | | | | | | | |
| Primer, g | 0.58 | 0.60 | 0.66 | 0.50 | 0.64 | 0.72 | 0.50 | 0.64 | 0.61 | 0.66 |
| Black, g | 0.21 | 0.23 | 0.23 | 0.21 | 0.24 | 0.24 | 0.22 | 0.24 | 0.20 | 0.21 |
| Clearcoat, g | 0.31 | 0.27 | 0.46 | 0.22 | 0.35 | 0.51 | 0.18 | 0.40 | 0.38 | 0.52 |

### EXAMPLES 8-10 AND COMPARATIVE EXAMPLE D

Compositions as given in Table 2 were made up in a 30 mm Werner & Pfleiderer twin screw extruder. All the ingredients except the Pelestat® were rear fed. This composition was then pellet blended with the Pelestat® and fed to a Nissei Japan 6 oz. injection molding machine, with the cylinder set at 315° C. and the mold set as 160° C., and molding into 7.6 cm×12.7 cm×0.32 cm thick plaques, wherein the molds were at 150° C. The plaques were tested for surface resistivity and dissipation voltage values, which are given in Table 2. The plaques were then electrostatically spray painted. Weights of the coatings are given in Table 2.

TABLE 2

| | Example | | | |
|---|---|---|---|---|
| | 8 | 9 | 10 | D |
| Polymer C | 36.7 | 34.7 | 32.7 | Steel |
| Polymer D | 36.65 | 34.6 | 32.5 | |
| Polymer E | 9 | 8.5 | 8 | |
| Engage ® 8180 | 7.2 | 6.8 | 6.4 | |
| Irganox ® 1010 | 0.45 | 0.4 | 0.4 | |
| Pelestat ® 6321 | 10 | 15 | 20 | |
| Surface Resistivity, | 7.5E+11 | 7.5E+11 | 7.5E+11 | |
| ohms/sq | | | | |
| Dissipation voltage | 5.0 | 1.4 | 0.7 | 0.0 |
| value, kV | | | | |
| Primer, g | 0.50 | 0.58 | 0.62 | 0.59 |
| Black, g | 0.22 | 0.24 | 0.27 | 0.18 |
| Clearcoat, g | 0.25 | 0.31 | 0.34 | 0.43 |

### EXAMPLES 11-18 AND COMPARATIVE EXAMPLE E-H

These compositions were made up in a 30 mm Werner & Pfleiderer twin screw extruder. Polymers F and B, and the Irganox®, and Ultranox® were fed in the rear of the extruder, while the Loxiol®, Vansil®, KetjenBlack, Pelestat®, and Plasthall® were side fed. This composition was fed to a Nissei Japan 6 ounce machine injection molding machine with 260° C. cylinder setting, 80° C. mold temperature, and molding into 7.6 cm×12.7 cm×0.32 cm thick plaques. For Examples 17 and 18 the procedures were the same except that the Pelestat® was not in the side fed to the extruder, and was instead pellet blended with the extruded composition and then fed to the injection molding machine. The plaques were tested for surface resistivity and dissipation voltage values. The plaques were then electrostatically spray painted. All data for these examples are given in Table 3.

TABLE 3

| | Example | | | | | |
|---|---|---|---|---|---|---|
| | E | 11 | 12 | 13 | F | 14 |
| Polymer F | 81.70 | 69.70 | 66.70 | 63.70 | 69.70 | 66.70 |
| Polymer B | 10.00 | 10.00 | 10.00 | 10.00 | 10.00 | 10.00 |
| Irganox ® 1010 | 0.10 | 0.10 | 0.10 | 0.10 | 0.10 | 0.10 |
| Ultranox ® 626 | 0.20 | 0.20 | 0.20 | 0.20 | 0.20 | 0.20 |
| Loxiol ® HOB7119 | 0.50 | 0.50 | 0.50 | 0.50 | 0.50 | 0.50 |
| Vansil ® HR 325 | 7.50 | 7.50 | 7.50 | 7.50 | 7.50 | 7.50 |
| KetjenBlack ® | | | | | | |
| EC600JD | | | | | | |
| Pelestat ® 6500 | | 12.00 | 15.00 | 18.00 | | |
| Pelestat ® 6321 | | | | | 12.00 | 15.00 |
| Dissipation Voltage | −17.0 | −2.0 | −0.1 | −0.1 | −8.0 | −2.0 |
| value, kV | | | | | | |
| Surface Resistivity, | 7.5E+12 | 7.5E+12 | 7.5E+11 | 2.5E+11 | 7.5E+12 | 7.5E+12 |
| ohms/sq | | | | | | |
| Primer, g | 0.17 | 0.51 | 0.63 | 0.68 | 0.42 | 0.55 |
| Basecoat, g | 0.21 | 0.24 | 0.26 | 0.27 | 0.27 | 0.23 |
| Clearcoat, g | 0.36 | 0.30 | 0.44 | 0.51 | 0.16 | 0.37 |

| | Example | | | | | |
|---|---|---|---|---|---|---|
| | 15 | G | 16 | 17 | 18 | H |
| Polymer F | 63.70 | 80.20 | 79.20 | 71.90 | 69.45 | Steel |
| Polymer B | 10.00 | 10.00 | 10.00 | 8.80 | 8.50 | |
| Irganox ® 1010 | 0.10 | 0.10 | 0.10 | 0.09 | 0.09 | |
| Ultranox ® 626 | 0.20 | 0.20 | 0.20 | 0.18 | 0.17 | |
| Loxiol ® HOB7119 | 0.50 | 0.50 | 0.50 | 0.44 | 0.43 | |
| Vansil ® HR 325 | 7.50 | 7.50 | 7.50 | 6.60 | 6.38 | |
| KetjenBlack ® | | 1.50 | 2.50 | | | |
| EC600JD | | | | | | |
| Pelestat ® 6500 | | | | 12.00 | 15.00 | |
| Pelestat ® 6321 | 18.00 | | | | | |
| Dissipation Voltage | −0.7 | −15.0 | −0.3 | −0.1 | 0.0 | 0.0 |
| value, kV | | | | | | |
| Surface Resistivity, | 7.5E+12 | 7.5E+12 | 4.3E+09 | 7.5E+12 | 3.8E+11 | |
| ohms/sq | | | | | | |
| Primer, g | 0.61 | 0.25 | 0.70 | 0.58 | 0.64 | 0.59 |
| Basecoat, g | 0.26 | 0.25 | 0.17 | 0.23 | 0.25 | 0.18 |
| Clearcoat, g | 0.38 | 0.32 | 0.54 | 0.41 | 0.48 | 0.43 |

### EXAMPLES 19-24 AND COMPARATIVE EXAMPLE I

Compositions were made up in a 30 mm Werner & Pfleiderer twin screw extruder. Polymers G, B and Lotader®, and the Irganox®, Ultranox®, Talc, Araidite®, EPON® and Loxiol® were fed in the rear of the extruder, while the PPG, Vansil®, and Plasthall® were side fed. This composition was then pellet blended with the Pelestat® and fed to a Nissei Japan 6 ounce machine injection molding machine with 290° C. cylinder setting, 120° C. mold temperature, and molding into 7.6 cm×12.7 cm×0.32 cm thick plaques. The plaques were tested for surface resistivity and dissipation voltage values. The plaques were then electrostatically spray painted, and the weights of the coatings measured. All data is given in Table 4.

TABLE 4

| | Example | | | | | | |
|---|---|---|---|---|---|---|---|
| | 19 | 20 | 21 | 22 | 23 | 24 | I |
| Polymer G | 64.60 | 59.50 | 64.60 | 59.50 | 49.09 | 51.21 | Steel |
| Lotader ® AX8900 | 3.40 | 8.50 | 0.00 | 0.00 | 3.40 | 3.40 | |
| Polymer B | 0.00 | 0.00 | 3.40 | 8.50 | 0.00 | 0.00 | |
| Irganox ® 1010 | 0.21 | 0.21 | 0.21 | 0.21 | 0.21 | 0.21 | |
| Ultranox ® 626 | 0.21 | 0.21 | 0.21 | 0.21 | 0.00 | 0.00 | |
| Talc 9102 | 1.70 | 1.70 | 1.70 | 1.70 | 0.85 | 0.85 | |
| Araldite ® ECN1299 | 0.43 | 0.43 | 0.43 | 0.43 | 0.43 | 0.43 | |
| EPON ® 1002F | 2.13 | 2.13 | 2.13 | 2.13 | 2.13 | 0.00 | |
| Loxiol ® HOB7119 | 0.43 | 0.43 | 0.43 | 0.43 | 0.00 | 0.00 | |
| PPG 3563 | 0.00 | 0.00 | 0.00 | 0.00 | 25.50 | 25.50 | |
| Vansil ® HR 325 | 8.50 | 8.50 | 8.50 | 8.50 | 0.00 | 0.00 | |
| Plasthall ® 809 | 3.40 | 3.40 | 3.40 | 3.40 | 3.40 | 3.40 | |
| Peletstat ® 6500 | 15 | 15 | 15 | 15 | 15 | 15 | |
| Dissipation Voltage | 1.0 | 0.3 | 1.2 | 5.0 | 0.0 | 0.3 | 0.0 |
| Value, kV | | | | | | | |
| Surface Resistivity, | 7.5E+12 | 7.5E+12 | 7.5E+12 | 7.5E+12 | 7.5E+12 | 7.5E+12 | |
| ohms/sq | | | | | | | |
| Primer, g | 0.59 | 0.71 | 0.69 | 0.45 | 0.61 | 0.56 | 0.65 |
| Base coat, g | 0.19 | 0.20 | 0.19 | 0.20 | 0.19 | 0.20 | 0.19 |
| Clear coat, g | 0.41 | 0.49 | 0.37 | 0.36 | 0.46 | 0.42 | 0.50 |

What is claimed is:

1. A process, comprising, coating a surface of a synthetic resin composition with a coating material, wherein said coating process is electrostatically assisted, wherein the improvement comprises, said composition has a surface resistance of about 5×10⁷ ohms/sq or more, and has a dissipation voltage value of less than about 5 kV.

2. The process as recited in claim 1 wherein said surface resistance is about 5×10⁸ ohms/sq or more, and said dissipation voltage value is less than about 3 kV.

3. The process as recited in claim 1 wherein said synthetic resin is a thermoset.

4. The process as recited in claim 1 wherein said synthetic resin is a thermoplastic.

5. The process as recited in claim 5 wherein said thermoplastic is a polyolefin, a poly(meth)acrylate, a polycarbonate, a fluorinated polymer, a polyester, a polyamide, a thermotropic liquid crystalline polymer, a polysulfone, poly(oxymethylene) homo- or copolymer, a polysulfide, a polyketone, an acrylonitrile-butadiene-styrene copolymer, a chlorinated polymer, or a thermoplastic elastomer, or blends thereof.

6. The process as recited in claim 1 wherein an electrically conductive filler is present.

7. The process as recited in claim 6 wherein said electrically conductive filler is carbon.

8. The process as recited in claim 1 wherein an ion-conducting resin is present.

9. The process as recited in claim 1 wherein said synthetic resin composition is part of a vehicle body or an appliance.
